(19) United States
(12) Patent Application Publication
(10) Pub. No.: US 2002/0106156 A1
(43) Pub. Date: Aug. 8, 2002

(54) Suppression of undesired wavelengths in feedback from pumped fiber gain media

(76) Inventors: Edward Vail, Menlo Park, CA (US); Radhakrishnan Nagarajan, Union City, CA (US); Harrison Ransom, Antioch, CA (US); Ian Booth, Sooke (CA); Tae Jim Kim, San jose, CA (US); Edmund Wolak, Palo Alto, CA (US); Jo Major JR., San Jose, CA (US); Stuart MacCormack, Mountain View, CA (US); Tanya Oleskevich, Victoria (CA)

Correspondence Address: KUDIRKA & JOBSE, LLP, ONE STATE STREET, SUITE 1510, BOSTON, MA, 02109, US

(21) Appl. No.: 09/776,288

(22) Filed: Feb. 2, 2001

Related U.S. Application Data
(60) Provisional application No. 60/223,819, filed on Aug. 9, 2000.
(60) Provisional application No. 60/228,946, filed on Aug. 29, 2000.
(60) Provisional application No. 60/235,242, filed on Sep. 25, 2000.

(51) Int. Cl. G02B 6/34

(52) U.S. Cl. 385/37

(57) ABSTRACT

An optical gain apparatus has a pump source providing pump energy at a pump wavelength to a gain medium that generates optical energy at a signal wavelength. To minimize disturbance from signal wavelengths appearing in a coupling path between the pump source and the gain medium, an optical attenuator is located in the coupling path that provides a significant degree of attenuation to signal wavelengths, while providing negligible attenuation of pump wavelengths. The attenuator may comprise a grating structure, such as a long period grating or a blazed grating. It may also comprise an angled coupling fiber that is oriented to reflect signal wavelengths out of the coupling path. The end of such a fiber would typically be formed into a microlens, such as a wedge-shaped lens or a biconic lens, and would preferably be coated with a material that is highly reflective at the signal wavelength, but anti-reflective at the pump wavelength. The microlens may also be angled relative to a longitudinal axis of the fiber. Other embodiments include the location of an attenuation component, such as scattering sites, absorbing material, or a refractive index change, at a radial position in the cladding of the optical fiber that affects the signal wavelength but not the pump wavelength.

### RELATED APPLICATIONS

This application takes priority from: U.S. Provisional Patent Application No. 60/223,819, filed Aug. 9, 2000; U.S. Provisional Patent Application No. 60/228,946, filed Aug. 29, 2000; and U.S. Provisional Patent Application No. 60/235,242, filed Sep. 25, 2000.

### FIELD OF THE INVENTION

This application relates to optical signal processing and, more particularly, to the amplification of optical signals with optical gain media, and the efficient pumping of such gain media.

### BACKGROUND OF THE INVENTION

An optical fiber gain medium is a device that increases the amplitude of an input optical signal. If the optical signal at the input to such an amplifier is monochromatic, the output will also be monochromatic, with the same frequency. A conventional fiber amplifier comprises a gain medium, such as a glass fiber core doped with an active material, into which is coupled an input signal. Excitation occurs from the absorption of optical pumping energy by the core. The optical pumping energy is within the absorption band of the active material in the core, and when the optical signal propagates through the core, the absorbed pump energy causes amplification of the signal transmitted through the fiber core by stimulated emission. Optical amplifiers are typically used in a variety of applications including but not limited to amplification of optical signals such as those that have traveled through a long length of optical fiber in optical communication systems.

Typical optical gain media are pumped by coupling the desired pump energy into the gain fiber. For example, an erbium-doped fiber may be pumped by coupling into the fiber a pump signal having a wavelength of 980 nm. This wavelength is within the absorption band of the erbium, and results in the generation of optical energy in the wavelength range of 1550 nm. Thus, for an optical amplifier having a signal with a wavelength of 1550 nm passing through the erbium-doped fiber, the signal is amplified by the generated 1550 nm energy when the fiber is pumped by a 980 nm pump source. A variety of optical couplers may be used to couple the pump signal into the amplifier fiber. One type of coupler is a wavelength division multiplexer (WDM), which has a wavelength selective characteristic that allows both the optical signal and the pump energy to be directed into the gain medium simultaneously. However, because the coupling between a pump source and the gain medium is typically not perfectly efficient, small amounts of the amplified signal can leak back toward the pump source. This signal leakage is undesirable, as it tends to reappear as noise in the gain medium.

### SUMMARY OF THE INVENTION

In accordance with the present invention, an optical gain apparatus is provided that attenuates optical energy at a signal wavelength that is present in the pumping path between the pump source and the gain medium of the apparatus. In particular, the optical energy at the signal wavelength is attenuated, while the optical energy at the wavelength of the pump source in the same optical path is not attenuated. The undesired wavelengths can arise from optical energy at the signal wavelength leaking back through the coupler between the pump source and the gain medium. If not removed, this optical noise can be reflected back to the gain medium and appear as noise in the amplified signal.

The present invention involves an optical gain apparatus that includes an optical gain medium, such as might be used with an optical fiber laser or an optical fiber amplifier. The gain medium provides signal energy at a signal wavelength for the purpose of developing a fiber laser output or amplifying an optical signal at the signal wavelength. Optical energy at the signal wavelength is prevented from being reflected back toward the gain medium by using a wavelength selective attenuator in an optical path between the pump source and the gain medium. This attenuator removes optical energy at the signal wavelength, while not significantly inhibiting a transmission of pump energy from the pump source to the gain medium.

The wavelength selective attenuator may take a number of different forms. For example, a Bragg grating may be used to separate the longer wavelengths from the shorter ones. A long period grating or a blazed grating tuned to the signal wavelength may be located in a coupling fiber between the pump source and the gain medium. Such a grating would tend to redirect the optical energy at the signal wavelength into the fiber cladding, thereby significantly limiting the amount of optical energy at the signal wavelength that can return to the gain medium.

In another embodiment of the invention, the attenuator makes use of a coupling fiber with an end surface that faces the pump source and receives the pump energy. The coupling fiber is separated from the pump source by a gap, and the end surface of the fiber is made such that optical energy at the signal wavelength that is directed to the end surface from within the fiber is reflected off the end surface into the fiber cladding. Given the geometrical orientation of the end surface, the signal wavelength energy is reflected out of the core of the fiber, and is thereby eliminated from the optical path between the pump source and gain medium. Preferably, an optical coating is used on the end of the fiber that is highly reflective to optical energy in the wavelength range of the signal wavelength, while not reflective (or minimally reflective) to optical energy in the wavelength range of the pump wavelength. This provides a higher degree of wavelength selectivity for this version of the optical attenuator.

In the foregoing arrangement, the end surface of the coupling fiber is typically fabricated into a microlens to enhance coupling efficiency. In one embodiment, the microlens is wedge-shaped to better handle the elliptical shape of the far field for the output of certain types of optical sources, such as semiconductor lasers. In an alternative embodiment, the microlens is a biconic lens, such that it has different radii of curvature in transverse directions across the lens. In either of these lens embodiments, it is preferable that the lens, i.e., an optic axis of the lens, is tilted relative to a longitudinal axis of the fiber in the vicinity of the end surface. This tilting of the lens can be used to increase the angle at which light at the signal wavelength is reflected away from the pump source, thereby improving the rejection efficiency at this wavelength. Moreover, for each of these embodiments, it is preferable that the coupling fiber be tilted relative to a center axis of the light emitted from the pump source. This angle takes into account the refraction of light at the pump wavelength as it passes through the microlens, and provides a high degree of coupling efficiency.

In another adaptation of the desired optical attenuator, a scattering or absorbing material may be integrated into the coupling fiber itself. In one embodiment, such a material, whether wavelength selective or not, is located in the cladding of the coupling fiber at a radial distance from the core that ensures that it is preferentially affects optical energy at the signal wavelength, but not at the pump wavelength. Such an arrangement relies on the different mode filling diameters of the different wavelengths, that is, on the relative radial extension of the evanescent energy of each. Since the longer wavelengths have an evanescent portion that extends further into the cladding region of the fiber, this fact may be used in selectively attenuating signal wavelengths while having a negligible effect on pump wavelengths. Thus, scattering sites or absorbent material are located at a radial position in the fiber cladding that has a significant overlap with the evanescent portion of optical energy at the signal wavelength, while having very little overlap with the evanescent portion of optical energy at the pump wavelength. These scattering sites or absorbent regions therefore attenuate the unwanted signal wavelengths while having little effect on the pump energy passing through the fiber. In a variation of this embodiment, a refractive index change is incorporated into the cladding of the fiber. The refractive index change, like the scattering sites or absorbing material, has a radial position in the cladding that is overlapped by the evanescent portion of the signal wavelengths but not overlapped to any significant degree by the pump wavelengths. The refractive index change disrupts the evanescent mode of the signal wavelengths, providing desired attenuation while having a negligible effect on the pump wavelengths.

As mentioned above, the radial position of an optical absorbing material may alone be sufficient to provide the desired wavelength selectivity. However, the absorbing material may also be selected to be preferentially absorbent for wavelengths in the wavelength range of the signal wavelength, while having a negligible absorbing effect on optical energy in the wavelength range of the pump wavelength. In an alternative embodiment, such a wavelength selective absorbing material may simply be incorporated into the core of the fiber. In such an embodiment, it is the character of the material and not its radial location that effects the desired attenuation of the signal wavelengths.

### BRIEF DESCRIPTION OF THE DRAWINGS

The above and further advantages of the invention may be better understood by referring to the following description in conjunction with the accompanying drawings in which:

FIG. 1 is a schematic view of an optical gain apparatus according to the present invention that includes a long wavelength attenuation element in an optical pumping input path;

FIG. 1A is a schematic perspective view of a grating fabrication process that may be used with the present invention;

FIG. 2 is a cross sectional side view of an embodiment of an attenuator in which a coupling fiber is angled relative to a pump source from which it receives pump energy;

FIG. 3 is a perspective view of a coupling fiber and pump source in which the coupling fiber has a biconic microlens;

FIG. 4 is a perspective view of a coupling fiber and pump source showing the relative orientation of different axes of the system;

FIG. 5 is a graphical view of the energy distribution of different wavelengths across the cross section of a fiber within which they propagate;

FIG. 6 is a schematic cross sectional view of an optical fiber that may be used as an attenuator and that has scattering centers located in the fiber cladding;

FIG. 7 is a schematic cross sectional view of an optical fiber that may be used as an attenuator and that has a region of absorbing material in the cladding that absorbs certain wavelengths of optical energy;

FIG. 8 is a schematic cross sectional view of an optical fiber that may be used as an attenuator and that has located in its cladding both optical scattering sites and an optical absorbing material;

FIG. 9 is a schematic cross sectional view of an optical fiber that may be used as an attenuator and that has an optical absorbing material located in its core;

FIG. 10 is a view with schematic and graphical components that depicts a refractive index change in an optical fiber that may be used as an attenuator.

### DETAILED DESCRIPTION

The present invention is directed to the removal of optical signal wavelengths from a pumping path between an optical pump source and a fiber optic gain medium. The removal of these wavelengths must be accomplished in a wavelength selective manner so that the pump energy being delivered from the pump source to the gain medium is not disrupted to any significant extent. A number of different ways of removing these wavelengths are provided herein.

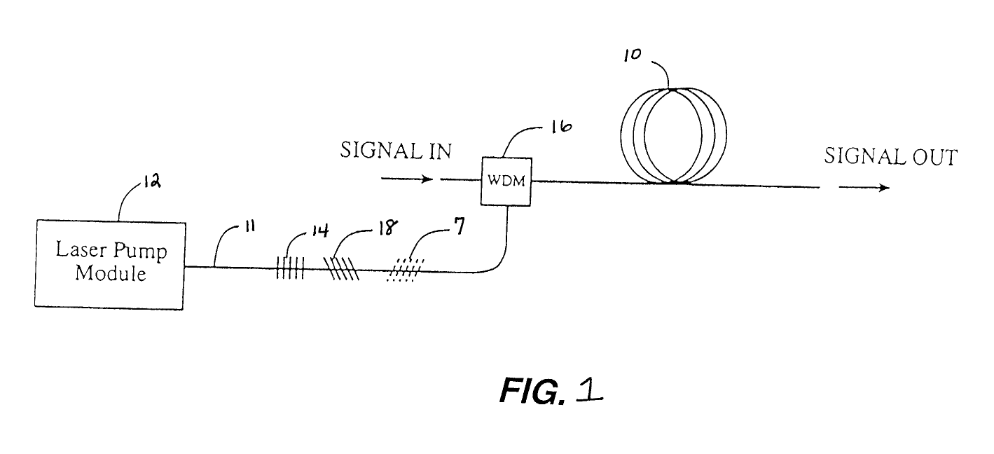

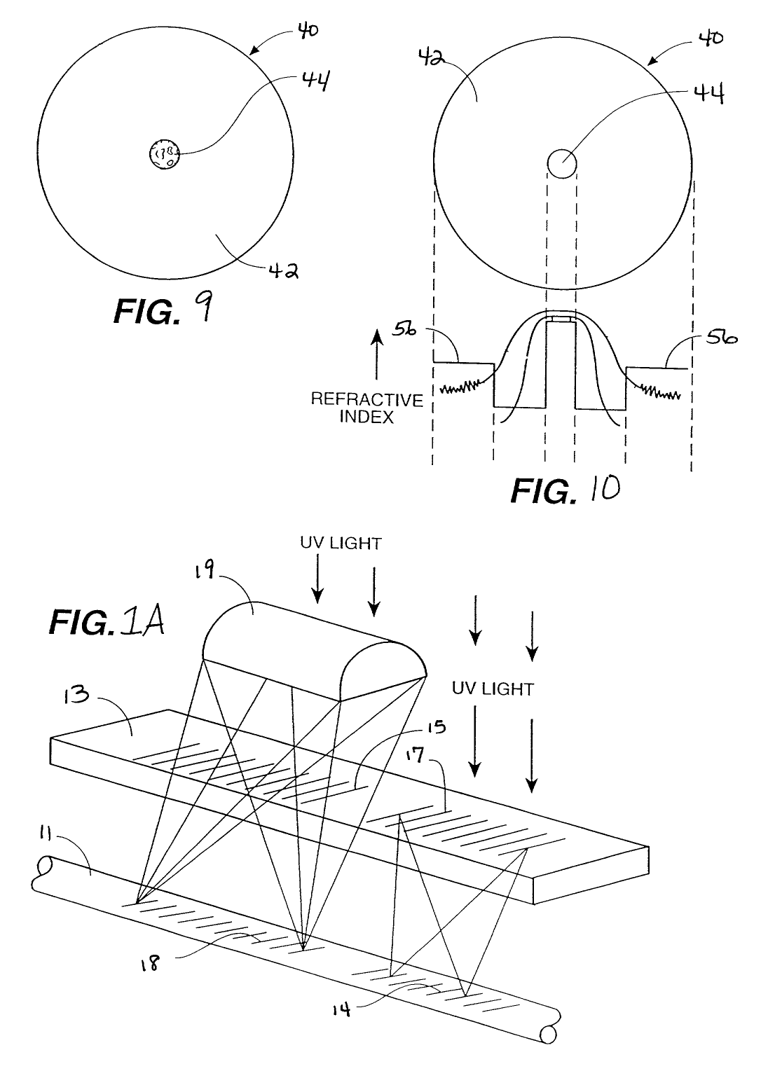

Shown in FIG. 1 is a first embodiment of the invention in which a doped fiber gain medium 10 is used as an optical fiber amplifier. An input signal is coupled into the fiber along with a pump signal generated by laser pump module 12. The optical fiber 11 connected to the pump module 12 (typically referred to as a “pigtail”) includes a feedback stabilization grating that helps to stabilize the output wavelength of the pump module 12. The input fiber and the pigtail from the pump module 12 are coupled into the input of the gain medium using wavelength division multiplexer (WDM) 16. However, despite the wavelength selective nature of the WDM 16, a certain amount of optical energy in the signal wavelength range leaks back through the WDM toward the pump module. This energy can be reflected back through the WDM 16, and ultimately appear as noise within the gain medium itself.

In order to attenuate the optical energy at the signal wavelengths in the fiber pigtail of the pump module 12, a blazed grating 18 is provided in the pigtail between the stabilization grating 14 and the WDM 16. Blazed gratings are well known devices that amount to periodic index modulations similar to fiber Bragg gratings. However, where a Bragg grating is oriented to reflect a particular narrow wavelength band back along an initial path through the fiber, a blazed grating is angled, or “blazed,” relative to a plane normal to the longitudinal axis of the fiber. The angling is such that the particular wavelength band selected by the grating is reflected at an angle relative to the longitudinal axis of the fiber that results in its exiting the core. As such, the blazed grating may be used as a filter to remove a certain band of wavelengths from the optical energy propagating through an optical fiber.

In the embodiment of FIG. 1, the blazed grating 18 is located between the pump source and the WDM and is reflective at a wavelength band centered around the wavelength of the optical signal being amplified, e.g., 1550 nm. The width of this reflectivity band depends upon the wavelengths that surrounding the signal wavelength that are to be suppressed. For example, a reflectivity band that suppresses wavelengths between 1535 nm and 1570 nm might be expected to ensure removal of stray signal wavelengths as well as amplified spontaneous emission (ASE) energy in the same range. The blazed grating 18 may be written directly into the pigtail fiber or may be spliced in as a separate element. In the preferred embodiment, the blazed grating 18 is written into the pigtail adjacent to the stabilization grating 14. This avoids duplication of several processes including hydrogen loading of the fiber for photosensitivity enhancement, stripping of the fiber jacket for grating writing, connection of the fiber to monitoring equipment for evaluation of the grating, annealing of the written gratings and recoating of the stripped fiber. It is also possible to expose the two gratings 14, 18 simultaneously using a composite phase mask. Because the two gratings 14, 18 have distinctly different periods and produce effects in separate wavelength bands, there is no interaction between them as a result of being rather close together in the pigtail fiber.

When using blazed gratings in the manner described above, it will be understood that, in operation, a blazed grating actually couples light from the core into one of the many cladding modes of the fiber. Each coupling mode will have a distinct wavelength based on the propagation constants of the core mode and the particular cladding mode, and the period of the grating. Therefore, the loss spectrum for the grating will typically be a series of many loss peaks covering a wavelength range of nanometers to several tens of nanometers. To provide a smoother loss profile, the fiber in the preferred embodiment is coated with a standard acrylite recoat. As a result, the cladding modes become lossy and the propagation constants become poorly defined, causing the loss spectrum to broaden into a smooth continuum. Other variations within this embodiment include making the blazed grating 18 tunable, such as by stretching or compressing the grating, as shown in U.S. Pat. Nos. 5,469,520 and 5,914,972, or through the application of piezoelectric vibrations, as shown in U.S. Pat. No. 5,159,601. It is also noted that the gain medium to which this embodiment applies is not limited to erbium-doped fibers, but includes numerous other types of optical gain media including, but not limited to, other types of doped fiber amplifiers and Raman amplifiers.

In a variation of this embodiment, the grating 18 could be a long-period grating rather than a blazed grating. A long period grating couples light from the core of a fiber into one or more of the cladding modes, as does a blazed grating. However, while a blazed grating reflects light into cladding mode in the direction opposite to that in which it was propagating in the core, a long period grating couples the core light into cladding modes propagating in the same direction. In either case, the cladding light is rapidly attenuated out of the fiber. Moreover, the long period grating has a longer periodicity and typically must be longer in total length to achieve the same attenuation as a blazed grating. The long period grating also requires a well-defined cladding mode or modes into which to couple the reflected light. Thus the long period grating cannot be recoated with acrylite and typically must be packaged hermetically more like a fused fiber coupler. In addition, a long period grating also tends to be more temperature dependent in its central wavelength than a blazed grating.

A method for fabricating a fiber with gratings as shown in the pigtail fiber of FIG. 1 is depicted schematically in FIG. 1A. The pigtail fiber 11 is prepared by providing a phase mask 13 with the appropriate grating features 15, 17 for forming a blazed grating and a standard Bragg grating (for stabilization of the laser), respectively. Alternatively, the two gratings could be in separate phase mask components, although using one phase mask is convenient. If separate phase mask components were to be used, grating features 15 could be made to be perpendicular to the longitudinal length of the mask component, and then rotated (or tilted) to achieve the formation of the blazed grating. In the method shown, a cylindrical lens 19 is located between the ultraviolet light source and the blazed grating phase mask component 15. This enhances the optical power provided to features 44 as compared to the features of mask component 42, thereby allowing an equal exposure time to be used for both gratings.

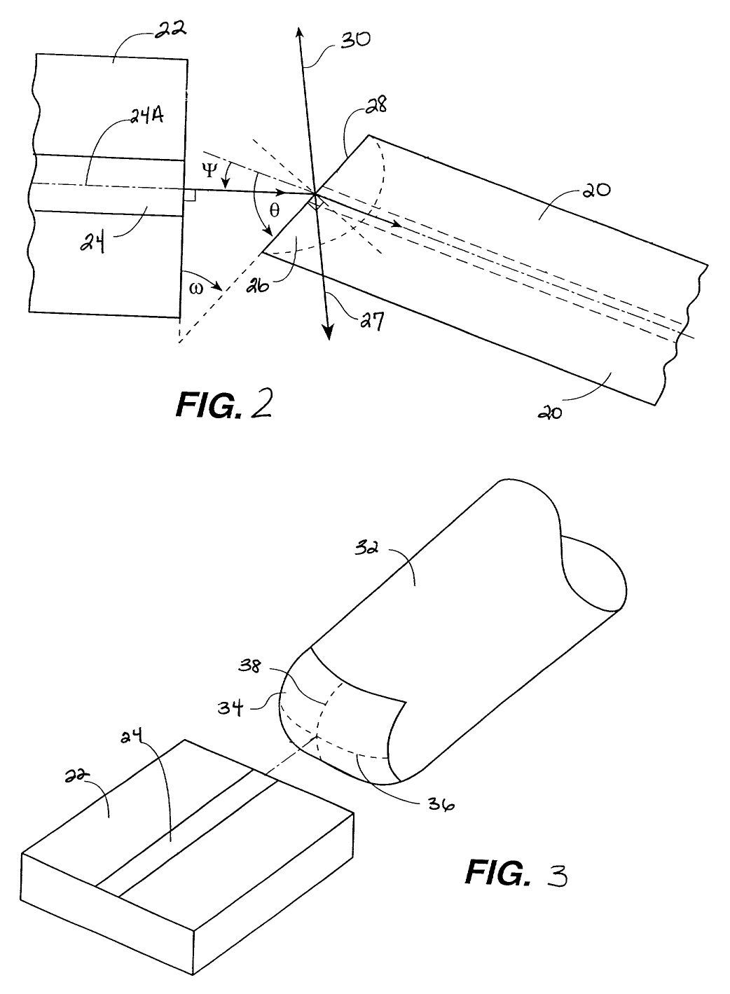

A second embodiment of the invention is shown in FIG. 2. In this embodiment, a coupling fiber 20 receives a pump signal from pump laser module 22. In the preferred embodiment, the laser module 22 is a laser diode that has an active region stripe 24 that provides light under lasing conditions along the longitudinal axis 24A of the stripe 24. The coupling fiber 20 is positioned at an angle relative to the laser stripe 24, that is, the fiber has a longitudinal axis in its core along which light propagates, and that longitudinal axis is at an angle relative to the longitudinal axis 24A of the laser module. However, the fiber is positioned such that light emitted from the laser module 24 is incident upon the end of the fiber 20 at the cross-sectional location of the core and, given the relative shape and positioning of the end surface of the fiber, optical pump energy at the desired pump wavelengths is conducted into the core of the coupling fiber 20. This fiber directs the pump energy to an optical gain medium via a coupler such as a WDM, in a manner essentially the same as that shown in the configuration of FIG. 1.

The end of the coupling fiber 20 that receives the optical pump energy from the module 22 is finished in such a way that it forms a microlens 26. In the preferred embodiment, this lens is wedge-shaped, having two substantially planar surfaces that form an apex 28. As is known in the art, a laser module such as module 22 typically has a far field pattern that is elliptical in shape. Therefore, the microlens of fiber 20 is preferably oriented so that the apex 28 is perpendicular to the major, or transverse, axis of the far field mode pattern. In this way, the wedge-shaped microlens collimates the light in the transverse direction, which is the dimension of highest divergence of output light from the laser module 20. However, the lens has no substantial effect on the divergence of output light in the minor axis, or lateral direction, of the far field pattern. In addition to the wedge shape, the present invention provides a relative angle between the longitudinal axis of the fiber 20 and the lens such that, as described above, the apex 28 of the wedge has an angle relative to the longitudinal axis of the fiber 20. Thus, the end of the fiber forms an “angled wedge.”

As shown in FIG. 2, the apex 28 of the angled wedge lens is positioned at an acute angle θ relative to the longitudinal axis. The specific value of the angle θ depends on the relative wavelengths being used, the specific parameters of the components and the relative position and orientation of the laser module 22 and the coupling fiber 20. The surface of the microlens is also coated with a wavelength selective highly reflective/anti-reflective (HR/AR) coating. The design of the HR/AR coating is selected to be highly reflective at a longer wavelength range and anti-reflective at a shorter wavelength range and is optimized for angled incidence, taking into consideration the range of incidence angles across the curved face of the fiber microlens 26. Such a coating may be designed by means well known in the art. In this embodiment, the coating is selected to be highly reflective in a longer wavelength range that encompasses the signal wavelength of a gain medium being pumped by the laser module 22. However, the coating is anti-reflective in a shorter wavelength range that encompasses the pump wavelength. As a result, optical energy at the pump wavelength passes easily through the coating. However, optical energy at the signal wavelength that reaches the lens 26 is reflected by the HR/AR coating. Because of the angling of the surface of lens 26, this higher wavelength light in the pumping path is scattered into the cladding modes of the fiber and dissipates. Light at the signal wavelength propagating along the fiber 20 toward the lens is reflected along a path shown by the arrow 27 in FIG. 2. As such, optical energy at the signal wavelength traveling in the optical path is therefore prevented from interfering with a gain medium being pumped.

With the angling of the microlens relative to the longitudinal axis of the fiber 20, possible reflection of light off the lens surface is also minimized. For example, when that angle is four degrees, the reflectivity of the lens surface is reduced by approximately 45 dB. Higher angles of six to eight degrees would decrease the reflectivity even more. This reduces the restrictions on the anti-reflective portion of the lens coating. In many cases it is desirable to keep the reflectivity of the coating quite low for the pump wavelength, for example −30 dB or even lower. The reasons for this include, for example, the efficient use of pump power.

As shown in FIG. 2, the components are positioned such that a relative tilt, indicated as angle “Ψ” in the figure, exists between the propagation axes of the fiber 20 and the pump module. By providing this relative orientation, a better coupling efficiency is achieved than would be obtained if the two components were coaxial. This fact is due to the relatively larger amount of optical energy coupled into the core of the fiber 20 through refraction when the fiber axis is at an angle relative to the axis of the laser module 22. In the past, a coupling fiber with a wedge-shaped microlens has been positioned at an angle relative to a pump source from which optical energy was coupled into it. The present embodiment has the benefits of the relative angle between the components as well as the benefits of the wedge-shaped lens.

Shown in FIG. 3 is another embodiment of the invention in which pump module 22 having a laser stripe 24 outputs a pump signal that is directed toward a coupling fiber 32. Unlike the coupling fiber of the FIG. 2 embodiment, however, the fiber 32 in FIG. 3 uses a biconic microlens 34. The biconic lens is anamorphic in that the radii of curvature of the major and minor axes of the lens (indicated, respectively, by reference numerals 36 and 38) are different. These different curvatures provide a correction for the difference in the divergence of light from the laser module 22 in the two perpendicular dimensions so as to maximize the coupling efficiency of the light output by the laser 22 into the fiber 32. The biconic lens is also advantageous in that it does not require as precise an alignment with the laser module as does the wedge-shaped lens. The specific radii of curvature 34, 36 for the lens are chosen according to the specific aspect ratio of the laser module's far field pattern.

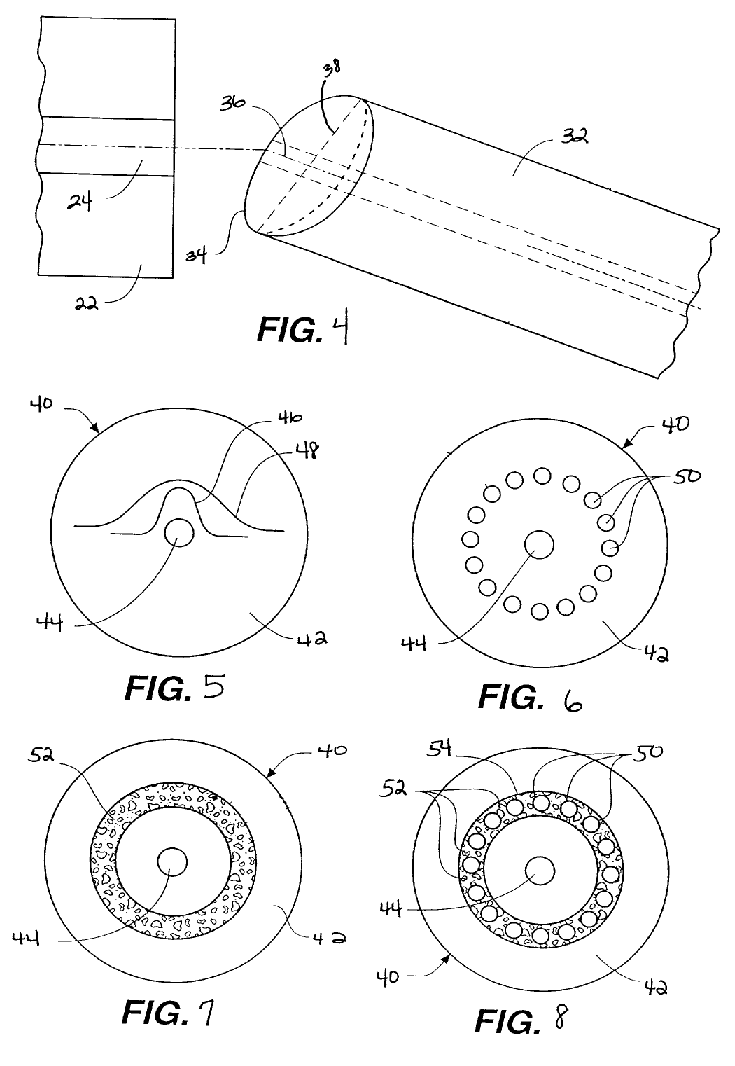

In FIG. 3, the biconic lens is angled, as with the angled wedge-shaped lens of FIG. 2, such that the optic axis of the lens is at an angle relative to the longitudinal axis of fiber 32. However, it is noted that the biconic lens 34 may also be used with its optic axis being coaxial with the longitudinal axis of the fiber. Moreover, the arrangement of FIG. 3 shows the longitudinal axis of the fiber being coaxial with the central axis of the pump light output from the laser module 22. However, it may also be desirable to angle the fiber relative to the laser module, as shown in FIG. 4. In the preferred version of this embodiment, the biconic microlens 34 is coated with an HR/AR coating similar to that described above with regard to the embodiment of FIG. 2.

Those skilled in the art will recognize that a coupling fiber having a biconic microlens may be used in other applications beyond those described herein. Used as part of a coupling fiber, the lens provides for correction in the aspect ratio of light being coupled into a fiber in which the lens is located. Its curvature also places less of a restriction than a wedge-shaped lens on achieving proper transverse alignment with a light source. With an angle of the lens relative to the longitudinal axis of the fiber that is appropriate for the specific refractive angle of the light entering the fiber, a high coupling efficiency can be achieved.

The specific shape of a biconic microlens depends on the specific application. However, given the disclosure herein, those skilled in the art will be able to adapt the lens shape to the desired application. In general, the radii of curvature of the large (horizontal) radius of the lens, and the small (vertical) radius of the lens depends on the far field divergence patterns of the light source. That is, such design parameters will depend on the nature of the light to be received with the lens, such as its wavefront characteristics, far field divergence angles and the like. Of course, other factors must also be taken into account, such as the fiber material, the refractive index of which, for example, will affect how the fiber lens will be shaped for purposes of optimization. Nevertheless, one skilled in the art of lens design will be capable of adapting the biconic lens disclosed herein to a particular application.

Shown in FIG. 5 is a schematic view of how a lossy fiber may be used to attenuate undesired longer wavelengths in the pigtail fiber of the pumping arrangement shown in FIG. 1. FIG. 5 depicts a cross-section of a fiber 40 having a cladding region 42 surrounding a core 44 within which light propagates. Shown schematically within the fiber are graphical depictions of the power distributions of two typical pump and signal wavelengths. The pump wavelength 46 is the shorter of the two wavelengths, and might be, perhaps, 980 nm. For this shorter wavelength, it can be seen that the bulk of the optical energy remains in the core region of the fiber 40. The longer of the two wavelengths, which might be a signal wavelength that has leaked back into the pigtail fiber from the gain medium, has an evanescent portion that extends to a much greater extent beyond the confining interface between the core 44 and the cladding 46. Given this difference in mode field diameter between the two wavelengths, the longer wavelength may be attenuated by loss elements in the cladding without significantly attenuating the shorter pump wavelength.

Shown in FIG. 6 is a schematic cross-sectional view of a pigtail fiber that might be used in the embodiment of FIG. 1. The fiber 40 has a core 44 and a cladding 42, as in the fiber shown in FIG. 4. In addition, however, the fiber has a number of scattering centers 50 distributed in the fiber cladding a certain radial distance from the core. The scattering centers 50 may comprise any of a number of known scattering materials that redirect light that intersects them out of the fiber. The scattering centers 50 are located at a predetermined radial distance from the core that ensures that there is no significant overlap between the evanescent portion of the pump light, but that there is a significant overlap of the evanescent portion of the higher wavelength signal light. This interaction with the signal light causes it to be scattered and its intensity reduced. As such, the scattering centers function as a wavelength selective loss element that remove the undesirable signal wavelength range from the pigtail fiber.

Another embodiment of the invention is shown in FIG. 7, in which a similar fiber 40 is depicted with core 44 and cladding 42. In this embodiment, a ring 52 of absorption centers is located within the cladding 42. As in the embodiment of FIG. 6, the ring is located a radial distance from the core that minimizes the extent to which it is overlapped by any evanescent portion of the pump wavelength 46, while ensuring a significant amount of overlap with the evanescent portion of the signal wavelength 48. In the preferred version of this embodiment, the absorbing ring 52 is of a material that is particularly absorbent at the signal wavelength. For example, given a signal wavelength of 1550 nm and a pump wavelength of 980 nm, the absorbing ring could contain erbium ions. While the erbium is also absorbent at the 980 nm pump wavelength, the lack of overlap with the evanescent portion of the pump energy prevents any significant loss at that wavelength.

Shown in FIG. 8 is another embodiment that relies on the relative mode filling diameters of the pump wavelength and the signal wavelength. In this embodiment, a fiber 40 is again provided that has a cladding 42 and a core. A ring 54 of material is again used, as in the embodiments of FIGS. 6 and 7. In the FIG. 8 embodiment, however, a combination of scattering centers 50 and absorbent material 52 is used to provide a highly effective reduction in the wavelengths in the range of the signal wavelength.

FIG. 9 shows an embodiment in which fiber 40 has cladding 42 and core 44. In this embodiment, an impurity is incorporated into the core 44. Obviously, unlike the cladding rings of previous embodiments, this impurity is encountered by all the wavelengths propagating in the core 44. However, in this case, the impurity itself is wavelength selective, and is absorbent at the signal wavelength while being essentially transparent at the pump wavelength. For a silica-based fiber, given a signal wavelength of 1550 nm and a pump wavelength of 980 nm, possible candidates for this impurity are parseodymium (Pr³⁺), europium (Eu³⁺), thulium (Tr³⁺) or combinations thereof.

In the embodiment of FIG. 10, again a pigtail fiber 40 has a cladding 42 and a core 44. Also shown in the figure is a graphical depiction of the change in refractive index across a cross-sectional plane of the fiber. As is convention, the core 44 has a relatively high refractive index and the region of the cladding adjacent the core has a relatively low refractive index, this giving the desired interface for allowing total internal reflection within the core. However, in this fiber, the cladding region 42 also includes a refractive index step 56. The index step 56 has a relative radial location in the cladding that ensures that it is significantly overlapped by the evanescent portion of a signal wavelength in the core, while being overlapped very little by the evanescent portion of a pump signal in the core. The interaction of the signal wavelength with this higher index step will spoil its evanescent mode and scatter it into the cladding. As such, this larger diameter mode will be lost, while the shorter pump wavelength will be virtually unaffected.

While the invention has been shown and described with regard to certain preferred embodiments, it will be recognized by those skilled in the art that various changes in form and detailed may be made herein without departing from the spirit and scope of the invention as defined by the appended claims. For example, many of the different attenuation methods described herein may be combined to provide a device with a better rejection of undesired signal wavelengths in the optical path between the pump source and the gain medium. Moreover, means of accomplishing the desired attenuation of the signal wavelengths other than those described explicitly herein may be available, but are considered to be well within the scope of the present invention.

What is claimed is:

1. An optical gain apparatus comprising:
an optical gain medium that absorbs optical energy at a pump wavelength and produces optical energy at a signal wavelength in response thereto;
an optical pump source generating optical energy at the pump wavelength and coupling it into the optical gain medium;
a wavelength selective attenuator located in an optical path between the pump source and the gain medium, the attenuator significantly inhibiting a transmission of optical energy at the signal wavelength to the gain medium, while not significantly attenuating a transmission of pump energy to the gain medium.

2. An optical gain apparatus according to claim 1 wherein the wavelength selective attenuator comprises a Bragg grating.

3. An optical gain apparatus according to claim 1 wherein the wavelength selective attenuator comprises a blazed grating.

4. An optical gain apparatus according to claim 1 wherein the wavelength selective attenuator comprises a long period grating.

5. An optical gain apparatus according to claim 1 wherein the wavelength selective attenuator comprises a coupling fiber separated by a gap from the pump source, the coupling fiber having an end surface through which pump energy is coupled from the pump source, the end surface being such that light in the coupling fiber at the signal wavelength that is directed to the end surface is coupled into a cladding mode of the fiber.

6. An optical gain apparatus according to claim 5 wherein the coupling fiber has a microlens fabricated in the end surface.

7. An optical gain apparatus according to claim 6 wherein the microlens is a wedge-shaped lens.

8. An optical gain apparatus according to claim 7 wherein the end surface is coated with a material that is highly reflective at the signal wavelength but not reflective at the pump wavelength.

9. An optical gain apparatus according to claim 7 wherein the coupling fiber has a longitudinal axis in the vicinity of the end surface that is at a substantial angle relative to an optic axis of the microlens.

10. An optical gain apparatus according to claim 6 wherein the microlens is a biconic lens.

11. An optical gain apparatus according to claim 10 wherein an optic axis of the biconic lens is at an angle relative to the longitudinal axis of the fiber in the vicinity of the end surface.

12. An optical gain apparatus according to claim 10 wherein the biconic lens has different radii of curvature in transverse directions across the lens.

13. An optical gain apparatus according to claim 10 wherein the end surface is coated with a material that is highly reflective at the signal wavelength but not reflective at the pump wavelength.

14. An optical gain apparatus according to claim 6 wherein the coupling fiber has a longitudinal axis in the vicinity of the end surface that is at a substantial angle relative to a center axis of light emitted from the pump source.

15. An optical gain apparatus according to claim 1 wherein the wavelength selective attenuator comprises a coupling fiber separated by a gap from the pump source, the coupling fiber having an end surface through which pump energy is coupled from the pump source, the end surface being coated with a material that is highly reflective at the signal wavelength but not reflective at the pump wavelength.

16. An optical gain apparatus according to claim 1 wherein the wavelength selective attenuator comprises a coupling fiber through which optical energy passes from the pump source to the gain medium, the coupling fiber having a core region and a cladding region, the cladding region having an attenuation component that attenuates optical energy at the signal wavelength, but does not significantly attenuate optical energy at the pump wavelength.

17. An optical gain apparatus according to claim 16 wherein the attenuation component comprises optical scattering sites.

18. An optical gain apparatus according to claim 16 wherein the attenuation component comprises an optical absorbing material.

19. An optical gain apparatus according to claim 18 wherein the optical absorbing material is highly absorbent at the signal wavelength, but has a negligible absorption at the pump wavelength.

20. An optical gain apparatus according to claim 16 wherein the attenuation component is located at a radial distance from the core for which there is high degree of overlap with an evanescent portion of optical energy in the core at the signal wavelength, but for which there is a negligible degree of overlap with an evanescent portion of optical energy in the core at the pump wavelength.

21. An optical gain apparatus according to claim 16 wherein the cladding contains a refractive index step at a radial distance from the core that is overlapped significantly by an evanescent portion of optical energy in the core at the signal wavelength, but not significantly overlapped by an evanescent portion of optical energy in the core at the pump wavelength, the refractive index step tending to cause scattering of the overlapping signal energy.

22. An optical gain apparatus according to claim 1 wherein the wavelength selective attenuator comprises a coupling fiber through which optical energy passes from the pump source to the gain medium, the coupling fiber having a core region and a cladding region, the core region containing a material that absorbs optical energy at the signal wavelength, but has no significant absorption of optical energy at the pump wavelength.

23. An optical gain apparatus comprising:
an optical gain medium that absorbs optical energy at a pump wavelength and produces optical energy at a signal wavelength in response thereto;
an optical pump source generating optical energy at the pump wavelength and coupling it into the optical gain medium;
a wavelength selective attenuator located in an optical path between the pump source and the gain medium, the attenuator significantly attenuating optical energy at the signal wavelength, while not significantly attenuating optical energy at the pump wavelength, wherein the wavelength selective attenuator comprises a coupling fiber having an end surface through which pump energy is coupled from the pump source, the end surface being such that any light at the signal wavelength within the fiber that is directed to the end surface is coupled into a cladding mode of the fiber.

24. An optical gain apparatus according to claim 23 wherein the coupling fiber has a biconic microlens fabricated in the end surface.

25. An optical gain apparatus according to claim 24 wherein the end surface is coated with a material that is highly reflective at the signal wavelength but not reflective at the pump wavelength.

26. An optical gain apparatus according to claim 23 wherein the coupling fiber has a wedge-shaped microlens fabricated in the end surface.

27. An optical gain apparatus according to claim 26 wherein the end surface is coated with a material that is highly reflective at the signal wavelength but not reflective at the pump wavelength.

28. An optical gain apparatus comprising:
an optical gain medium that absorbs optical energy at a pump wavelength and produces optical energy at a signal wavelength in response thereto;
an optical pump source generating optical energy at the pump wavelength and coupling it into the optical gain medium;
a wavelength selective attenuator located in an optical path between the pump source and the gain medium, the attenuator significantly attenuating optical energy at the signal wavelength, while not significantly attenuating optical energy at the pump wavelength, wherein the wavelength selective attenuator comprises a coupling fiber through which optical energy passes from the pump source to the gain medium, the coupling fiber having a core region and a cladding region, the cladding region having an attenuation component that attenuates optical energy at the signal wavelength, but does not significantly attenuate optical energy at the pump wavelength.

29. An optical gain apparatus according to claim 28 wherein the attenuation component is located at a radial distance from the core for which there is high degree of overlap with an evanescent portion of optical energy at the signal wavelength, but for which there is a negligible degree of overlap with an evanescent portion of optical energy at the pump wavelength.

30. An optical gain apparatus according to claim 28 wherein the attenuation component comprises optical scattering sites.

31. An optical gain apparatus according to claim 28 wherein the attenuation component comprises an optical absorbing material.

32. An optical coupling medium comprising an optical fiber with a first end that receives light from outside of the fiber, the first end being formed to the shape of a biconic microlens, the biconic microlens having different radii of curvature in transverse directions across a face of the lens.

33. A method of providing optical pumping energy to an optical gain medium that absorbs optical energy at a pump wavelength and produces optical energy at a signal wavelength in response thereto, the method comprising:
generating optical energy at the pump wavelength with an optical pump source and coupling it into the optical gain medium via an optical path between the pump source and the gain medium; and
locating a wavelength selective attenuator in the optical path, the attenuator significantly attenuating optical energy at the signal wavelength, while not significantly attenuating optical energy at the pump wavelength.

34. A method according to claim 33 wherein the wavelength selective attenuator comprises a Bragg grating.

35. A method according to claim 33 wherein the wavelength selective attenuator comprises a blazed grating.

36. A method according to claim 33 wherein the wavelength selective attenuator comprises a long period grating.

37. A method according to claim 33 wherein the wavelength selective attenuator comprises a coupling fiber separated by a gap from the pump source, the coupling fiber having an end surface through which pump energy is coupled from the pump source, the end surface being such that light in the coupling fiber at the signal wavelength that is directed to the end surface is coupled out of the optical path of the fiber.

38. A method according to claim 37 wherein the coupling fiber has a microlens fabricated in the end surface.

39. A method according to claim 38 wherein the microlens is a wedge-shaped lens.

40. A method according to claim 39 wherein the coupling fiber has a longitudinal axis in the vicinity of the end surface that is at a substantial angle relative to an optic axis of the microlens.

41. A method according to claim 40 wherein the microlens is a biconic lens.

42. A method according to claim 40 wherein an optic axis of the biconic lens is at an angle relative to the longitudinal axis of the fiber in the vicinity of the end surface.

43. A method according to claim 40 wherein the biconic lens has different radii of curvature in transverse directions across the lens.

44. A method according to claim 38 wherein the end surface is coated with a material that is highly reflective at the signal wavelength but not reflective at the pump wavelength.

45. A method according to claim 38 wherein the coupling fiber has a longitudinal axis in the vicinity of the end surface that is at a substantial angle relative to a center axis of light emitted from the pump source.

46. A method according to claim 33 wherein the wavelength selective attenuator comprises a coupling fiber through which optical energy passes from the pump source to the gain medium, the coupling fiber having a core region and a cladding region, the cladding region having an attenuation component that attenuates optical energy at the signal wavelength, but does not significantly attenuate optical energy at the pump wavelength.

47. A method according to claim 46 wherein the attenuation component comprises optical scattering sites.

48. A method according to claim 46 wherein the attenuation component comprises an optical absorbing material.

49. A method according to claim 48 wherein the optical absorbing material is highly absorbent at the signal wavelength but has a negligible absorption at the pump wavelength.

50. A method according to claim 46 wherein the attenuation component is located at a radial distance from the core for which there is high degree of overlap with an evanescent portion of optical energy at the signal wavelength, but for which there is a negligible degree of overlap with an evanescent portion of optical energy at the pump wavelength.

51. A method according to claim 46 wherein the cladding contains a refractive index step at a radial distance from the core that is overlapped significantly by an evanescent portion of optical energy in the core at the signal wavelength, but not significantly overlapped by an evanescent portion of optical energy in the core at the pump wavelength, the refractive index step tending to cause scattering of the overlapping signal energy.

52. A method according to claim 33 wherein the wavelength selective attenuator comprises a coupling fiber through which optical energy passes from the pump source to the gain medium, the coupling fiber having a core region and a cladding region, the core region containing a material that absorbs optical energy at the signal wavelength, but has no significant absorption of optical energy at the pump wavelength.

53. A method of providing optical pumping energy to an optical gain medium that absorbs optical energy at a pump wavelength and produces optical energy at a signal wavelength in response thereto, the method comprising:
generating optical energy at the pump wavelength with an optical pump source and coupling it into the optical gain medium;
locating a wavelength selective attenuator in an optical path between the pump source and the gain medium, the attenuator significantly attenuating optical energy at the signal wavelength, while not significantly attenuating optical energy at the pump wavelength, wherein the wavelength selective attenuator comprises a coupling fiber separated by a gap from the pump source, the coupling fiber having an end surface through which pump energy is coupled from the pump source, the end surface being such that any light at the signal wavelength within the fiber that is directed to the end surface is coupled out of the optical path of the fiber.

54. A method according to claim 53 wherein the coupling fiber has a biconic microlens fabricated in the end surface.

55. A method according to claim 54 wherein the end surface is coated with a material that is highly reflective at the signal wavelength but not reflective at the pump wavelength.

56. A method according to claim 53 wherein the coupling fiber has a wedge-shaped microlens fabricated in the end surface.

57. A method according to claim 56 wherein the end surface is coated with a material that is highly reflective at the signal wavelength but not reflective at the pump wavelength.

58. A method of providing optical pumping energy to an optical gain medium that absorbs optical energy at a pump wavelength and produces optical energy at a signal wavelength in response thereto, the method comprising:
generating optical energy at the pump wavelength with an optical pump source and coupling it into the optical gain medium;
locating a wavelength selective attenuator in an optical path between the pump source and the gain medium, the attenuator significantly attenuating optical energy at the signal wavelength, while not significantly attenuating optical energy at the pump wavelength, wherein the wavelength selective attenuator comprises a coupling fiber through which optical energy passes from the pump source to the gain medium, the coupling fiber having a core region and a cladding region, the cladding region having an attenuation component that attenuates optical energy at the signal wavelength, but does not significantly attenuate optical energy at the pump wavelength.

59. A method according to claim 58 wherein the attenuation component is located at a radial distance from the core for which there is high degree of overlap with an evanescent portion of optical energy in the core at the signal wavelength, but for which there is a negligible degree of overlap with an evanescent portion of optical energy in the core at the pump wavelength.

60. A method according to claim 58 wherein the attenuation component comprises optical scattering sites.

61. A method according to claim 58 wherein the attenuation component comprises an optical absorbing material.
